(19) United States
(12) Patent Application Publication
(10) Pub. No.: US 2016/0034853 A1
(43) Pub. Date: Feb. 4, 2016

(54) DETERMINING A USER'S LATENT PREFERENCE

(71) Applicant: Linkedln Corporation, Mountain View, CA (US)

(72) Inventors: Jian Wang, Mountain View, CA (US); David Hardtke, Oakland, CA (US)

(21) Appl. No.: 14/526,836

(22) Filed: Oct. 29, 2014

Related U.S. Application Data
(60) Provisional application No. 62/031,413, filed on Jul. 31, 2014.

(51) Int. Cl. G06Q 10/10; G06N 5/02; G06F 17/30

(52) U.S. Cl. CPC G06Q 10/1053; G06F 17/3053; G06F 17/30687; G06F 17/30705; G06N 5/022

(57) ABSTRACT

Generally discussed herein are methods, systems, and apparatuses for determining a latent preference of a user. One or more embodiments, discussed herein regard determining a latent preference of a user's propensity to relocate for a job. According to an example, a method can include receiving one or more characteristics of a user of a web service, estimating a probability corresponding to a latent preference of the user, and/or determining whether the probability indicates the user has the latent preference.

### RELATED APPLICATION

The present application claims priority to U.S. Provisional Patent Application No. 62/031,413, filed on Jul. 31, 2014, entitled “IDENTIFYING AND LEVERAGING A USER'S LATENT LOCATION PREFERENCE”, which is incorporated herein by reference in its entirety.

### TECHNICAL FIELD

Examples generally relate to systems, apparatuses, and methods for determining a latent preference of a user and some examples can relate specifically to determining a user's propensity to relocate for a job.

### BACKGROUND

A recommender system generally presents one or more recommendations to a user. A recommendation is usually determined by first predicting a user's ratings for an item and then ranking that item against other ranked items in some order (e.g., where the rank is predicted by the system or given by a user). Two common approaches to providing a recommendation include content-based filtering and collaborative filtering.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed herein.

FIG. 1 shows a block diagram of an example of a latent preference determination system, in accord with one or more embodiments.

FIG. 2 shows a flow diagram of an example of a method for determining a user's propensity to relocate, in accord with one or more embodiments.

FIG. 3 shows a block diagram of an example of a social network environment, in accord with one or more embodiments.

FIG. 4 shows a block diagram of an example of a device upon which any of one or more techniques (e.g., methods) discussed herein can be performed.

### DESCRIPTION OF EMBODIMENTS

Discussed generally herein are systems, devices, and methods for determining a latent preference of a user. In one or more embodiments, the latent preference can be based on a determined probability that a user is or is not willing to relocate for a job.

In one or more embodiments, one or more characteristics of a user are received. The characteristics of a user can include age, gender, seniority at a job, geographical region, among others. The characteristics can be used as an input to a machine-learning module (e.g., a latent preference module) that can determine a probability that a user is willing to relocate for a job based on the characteristics. The determined probability can be compared to a threshold, and a user with a probability at or below the threshold can be determined to be a local user (i.e. a user that is not willing to relocate for a job). Users determined to have a probability above the threshold can be determined to be willing to relocate for a job. Note that a user that is willing to relocate for a job can be presented with a job local to the user, but a user that is not willing to relocate for a job can find a non-local job recommendation offensive and can be presented with only local jobs, such as can be dependent on a determined probability that the user is willing to relocate for a job. If a user is determined to be indifferent to job locality (e.g., a determined probability that the user is willing to relocate for a job is about fifty percent), both local and non-local jobs can be presented to the user. If it is determined that a user has a high probability of relocating for a job, only jobs that are not local to the user can be presented to the user, in one or more embodiments. For a local user, jobs that are not local to the user can be filtered out of a list of potential jobs that a recommender system uses in providing a recommendation to the local user. Thus, the non-local jobs are not presented to the user if the user is determined to be a local user. Similarly, local jobs can be filtered out for a non-local user.

While the discussion herein is generally focused on providing a user with a job recommendation that is in a location the user is interested in working in, the apparatuses, systems, and methods discussed herein can be used for filtering out (e.g., removing) potential downside item recommendations (a recommendation of an item that decreases the user experience and satisfaction when recommended) in other areas, such as a dining, a movie, or other product or service recommendation.

Recommender systems generally focus on recommending an upside item (an item that improves the user experience and satisfaction when recommended). An upside management recommender system generally focuses on finding the “best” item(s) to recommend to a user. Better upside management can be achieved by leveraging recommendation systems, such as collaborative filtering, content based filtering, contextual modeling, a matrix factorization, a deep learning neural network, a combination thereof, and so on, and combining them with a downside management system, such as a latent preference system discussed herein.

Content-based filtering assumes that descriptive features of an item indicate a user's preference(s). Thus, a content-based recommender system makes a recommendation for a user based on the descriptive features of other items the user likes or dislikes (e.g., the user has ranked relatively high or relatively low). For example, if a user has expressed an interest in learning about programming in Python, a recommender system can infer the user has an interest in programming in Java. Generally, these recommender systems recommend items that are similar to what the user has previously liked.

Collaborative filtering, assumes that users with similar tastes on some items may also have similar preferences on other items. Thus, a collaborative filtering based recommender system uses the behavior history of a user and other “like-minded” users to provide the current user with a recommendation. For example, if two users are determined to both like the Green Bay Packers, and one of the two users has purchased Vince Lombardi's biography, a collaborative filtering system can recommend Vince Lombardi's biography to the other user.

Context-aware recommender systems (contextual modeling systems) focus on using user contextual information (e.g., a user's location, type of device the user is using, such as desktop, laptop, phone, etc., a browser the user is using, how long the user has been on a web page, what web pages the user previously visited, among others) to improve upside recommendation management. For example, a user can be more likely to make a purchase using a desktop and more likely to interact with an ad using a mobile phone, so a user can be recommended items for purchase on the desktop and items to interact with on the mobile phone.

A hybrid recommender system combines aspects of at least two of collaborative filtering, content-based filtering, and contextual modeling in providing a recommendation. Most existing hybrid (e.g., logistic regression, gradient boosting tree, etc.) and non-hybrid recommender systems consider all characteristics of a user and an item together to predict a single probability that a user will be interested in an item.

The item can be recommended to a user according to its high probability if the content match (content-based filtering probability) is high even though a collaborative filtering probability match is low. A user might not complain about a recommendation that the user is not interested in, but does not find offensive. However, a user can be less tolerant to be provided with a downside recommendation, such as a recommendation associated with an inappropriate location, an inappropriate product category, or otherwise inappropriate given the user's characteristics (e.g., contextual information, demographics, likes, dislikes, or the like, among others). Thus, it would be hard to find the right threshold on a single probability from the existing recommender system if a downside item is about a single specific characteristic of a user.

For at least the foregoing reasons, downside item management is an important topic in the field of recommender systems. User satisfaction can increase when a good item is recommended, but user-satisfaction can drop when a bad recommendation is provided. For example, a user can stop using a system after a bad recommendation is provided to them. Examples of bad recommendations can include recommending a steakhouse to a vegetarian or recommending an intern job to a Chief Executive Officer (CEO). Other examples include recommending an inappropriate movie to a young user, recommending memorabilia depicting a sports team, actor, movie, television or internet program, or other entity that the user does not like, among others.

Under circumstances where there is a penalty for a bad recommendation, a bad recommendation can be worse than no recommendation at all. While most recommendation systems focus on upside item management (recommending a “best” item to a user), a system, apparatus, or method discussed herein can help achieve an improvement in downside item management (e.g., reducing an amount of recommendations of irrelevant or offensive items to users). One or more approaches discussed herein are general and can be applied to a scenario or domain where downside management can be beneficial.

A user latent preference model can help predict a user latent preference (e.g., a propensity to relocate, such as for a job) given a user characteristic (e.g., age group, gender, and the like). This user characteristic is sometimes referred to herein as a dimension. A multinomial regression can provide at least a portion of the model of the preference. The regression can be extended with a hierarchical Bayesian framework, such as to help manage data sparsity. After the user latent preference is predicted, downside items (items that are determined to be inconsistent with an inferred user preference) can be filtered out using the latent preference model.

A user latent geographical preference model for relocating for a job was evaluated using an anonymous job application dataset from LinkedIn®. The latent geographical preference model evaluated can help increase a user Views per Image (VPI) (where an impression includes displaying some content (e.g., an item) to a user) or Applications per Impression (API), thus helping to reduce the Cost per Impression (CPI) and increasing an effectiveness or profitability of displaying the item.

The core of the framework evaluated was a multinomial regression that models a user's latent preference in a specific dimension. The user's latent preference (e.g., propensity to relocate for a job) could either be binary (for example, work at a nearby job, or take a job that requires relocation) or multi-class (for example, work as the intern level, senior level, staff level, or executive level). As used herein, a “segment of users” is a group of users that include one or more common characteristic or a range of characteristics. The characteristics of a user can include data expressly given by a user or gathered about a user.

For example a user characteristic can include an age (e.g., birthdate), a gender, a date the user last modified or updated their profile, a date the user began or finished education, a location of a user's current job, among others. For example, the segment of users with the characteristic of age twenty-two can include users twenty-two years old. In at least one study it was determined that a segment of job-seeking, twenty-two year old users were determined to be more willing to relocate for a job than any other age group of segment of job-seekers.

While the framework proposed is general to any downside items associated with a specific dimension in a wide variety of domains, the framework is presented with regard to a location dimension in a job recommendation domain. In other words, the framework, as presented herein, aims to avoid recommending jobs in locations where the job seeker would not want to work, but the framework can be used to help avoid bad recommendations in other dimensions. The training data and segments associated with the multinomial regression can be changed to provide a framework to help avoid a bad recommendation in another dimension.

The model was evaluated with both an online anonymous job application dataset and real-world job seekers on LinkedIn®. An analysis showed that a user latent preference model, as described herein can help to improve the VPI (views per impression) and API (applications per impression) metrics. At the same time, the absolute number of applications and views per impression can increase in spite of fewer impressions. Such performance follows from the user latent preference model achieving better downside management, which in turn can result in higher user satisfaction.

Users in different segments (e.g., users with different characteristic vectors) may have different parameters or tendencies for latent preferences. For example, some age groups of younger people tend to relocate for a job more than older people and people in bigger cities generally tend to relocate less than those in small cities. To accommodate this variation in users, one regression model can be learned per user segment. Users can be segmented by characteristic, such as by a characteristic that is determined to be relevant to a dimension or domain of the recommendation. For example, users for a location dimension in a job recommendation domain can be segmented by an age, gender, job seniority, job title, job industry, location, characteristic, or a combination thereof, among others. How to segment a user can be determined by a domain expert or an experiment, or a combination thereof, among other. In most instances, a small number of user segments encompass a majority of users, while most segments have few users. To address the problem of data sparsity (e.g., to allow a recommendation framework to function properly on a segment with a smaller number of users or observations) the model can be extended with a hierarchical Bayesian framework. The extended framework can help a segment with fewer users or observations by borrowing information from other segments through a common parameter of multinomial regression. A discussion of multinomial regression and a hierarchical Bayesian framework are provided after a discussion of the FIGS. below.

Reference will now be made to the Figures to describe details of one or more embodiments. Generally the embodiments are discussed with reference to a social network system that can provide a recommendation to a user, however, the recommender system is not limited to this context. The system(s), apparatus(es), and method(s) can be implemented in a recommender application that can be implemented on a computing device as a standalone, add-on, or plug-in for another application, among other implementations.

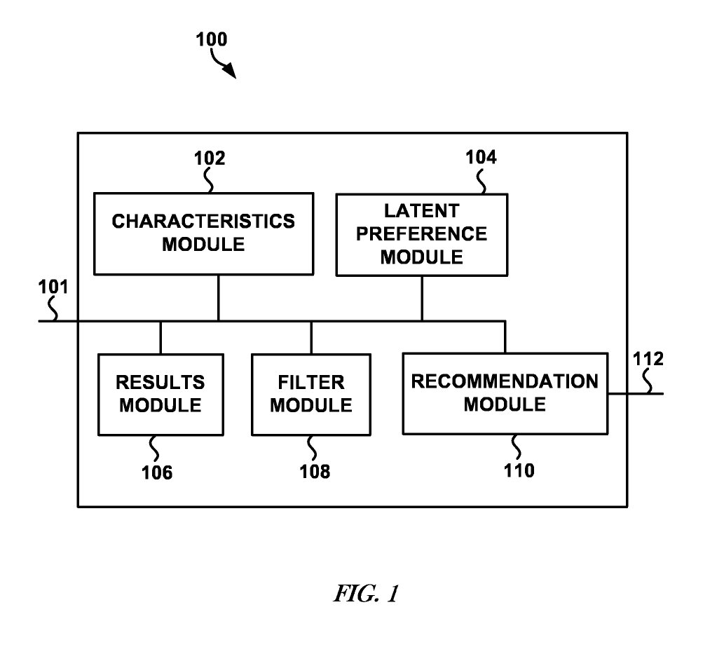

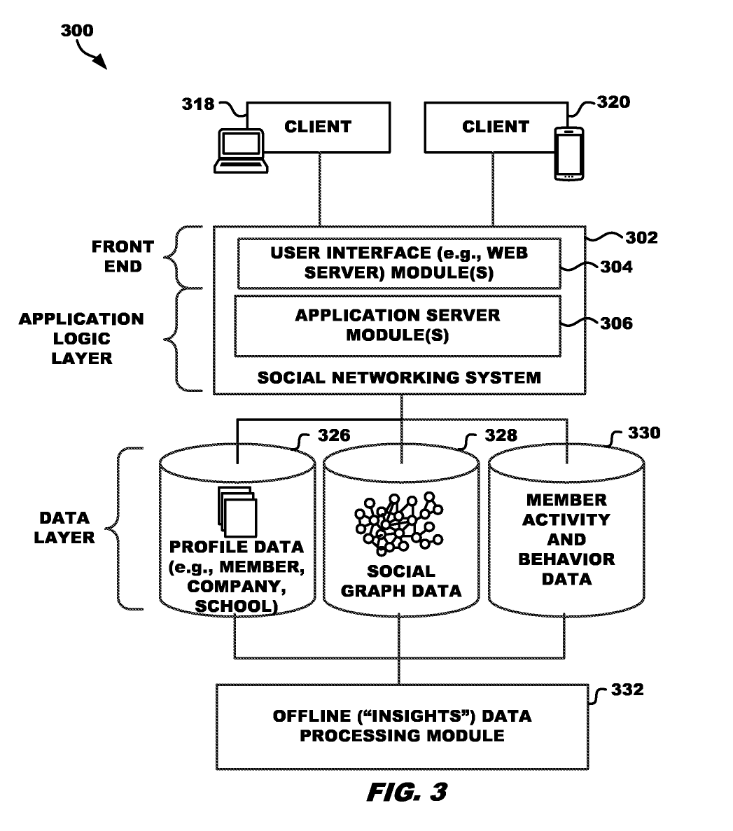

FIG. 1 shows a block diagram of an example of a system 100 for determining a latent preference of a user, in accord with one or more embodiments. The system 100 can include one or more of a characteristics module 102, a latent preference module 104, a results module 106, a filter module 108, or a recommendation module 110. One or more of the modules of the system 100 can operate in or provide functionality to the application server modules 306 or the offline data processing module 332 of FIG. 3.

The characteristics module 102 can receive (e.g., passively or actively, such as by retrieving or accessing) one or more characteristics of a user or segment of users, such as from the input 101. The characteristics can include information about a user that is provided by the user, inferred about the user, or gathered about a user, such as can be gathered by accessing a database. In one or more embodiments, the characteristics module 102 can infer another characteristic of a user from one or more characteristics received, such as at the input 101. For example, data regarding a user's job history can be at least partially provided by the user or at least partially determined by accessing one or more public records. In one or more embodiments, the characteristics module 102 can receive the one or more characteristics from the profile data database 326 or the user activity and behavior data database 330 (see FIG. 3), for example.

A characteristic of a user can include the user's name, an age (e.g., birthdate), a gender, interests, contact information, home town, current or prior address, names of the user's spouse and/or family users, a date the user last modified or updated their profile, a date the user registered for the web service, am educational background of the user (e.g., schools, majors, matriculation and/or graduation dates, a date the user began or finished education, etc.), a location of a user's current job (e.g., a geographical region or postal code associated with the user's current job), employment history, seniority (e.g., experience in a specific field or a title associated with a specific job, an amount of time working at a job, or the like), job related skills, professional or other organization memberships, a current geographical region of the user, a postal code associated with the user's current job, among others. The characteristic(s) of a user can be provided to the latent preference module 104. The characteristic of the user can be provided by the user, gathered, or determined from user activity or behavior data, such as from the user activity and behavior data database 330 (see FIG. 3), for example.

The latent preference module 104 can determine a latent preference of a user using the characteristic(s) of the user. The latent preference module 104 can estimate a probability that a user or segment of users is interested in an item (e.g., an item associated with an advertisement, such as a restaurant, movie, article of clothing, video, program, event, or other item associated with an advertisement, a job posting (e.g., a local job posting or a non-local job posting, a job posting in a specific industry, a job posting with a specific title, or a combination thereof), another user (e.g., a company, or other user), or other item) based on a characteristic of the user or segment. In one or more embodiments, the latent preference module 104 can determine a probability associated with a user's propensity to relocate for a job.

The probability can be estimated using a multinomial regression model, such as discussed herein, a hierarchical Bayesian framework, such as discussed herein, or a combination thereof (called “hierarchical multinomial regression” herein), or other learning method. The multinomial regression model can be one of multiple multinomial regression models, wherein each multinomial regression model (e.g., hierarchical multinomial regression) models a segment of users. Each segment of users can include users that have registered for a web service and/or have a common characteristic. The parameters associated with one multinomial regression model can be different than the parameters associated with another multinomial regression model such that different segments of users can have different probabilities associated with a same latent preference. The parameters can be determined using a prior determined statistic regarding users that include one or more same or similar characteristic(s).

For example, in the context of a user's propensity to relocate for a job, a user in a segment defined by the characteristic of age can be more likely to relocate for a job if the user is age twenty-two as compared to any other age group. Some statistics show that eighteen year old users and users twenty-five years old and older tend not to relocate for a job (e.g., more than fifty percent of users in these segments tend to remain in local jobs), while those in the age range of twenty-one to twenty-four tend to relocate for a job (e.g., more than fifty percent of users in these segments tend to relocate for a job). In a multinomial regression, to determine a user's propensity to relocate for a job, a parameter (e.g., a weighting factor) associated with an age characteristic of a twenty-two year old user can be less than or greater than a parameter associated with the age characteristic of an eighteen year old user, since twenty-two year old users tend to relocate for a job more than eighteen year old users. Some statistics have shown that the probability of staying in the same region for a job does not increase as a user gets older. Some statistics show the probability of relocating for a job stabilizing at about forty-five percent (fifty-five percent chance that the user will not relocate for a job) as the user gets older.

In another example, some statistics show that a user including a male characteristic is more likely to relocate for a job than a user that includes a female characteristic. Thus, the parameter associated with a user characteristic of gender in a relocating for a job domain can be higher for a male user than for a female user.

In another example, a user that includes a characteristic of currently working in a city with a large population (e.g., San Francisco Bay area, greater New York City area, Houston, Tex. area, greater Denver area, greater Seattle area, greater Chicago area, greater Minneapolis-St. Paul area, greater Atlanta area, Dallas/Fort Worth area, Orange County, Calif. area, or the like) is less likely to relocate for a job than a user currently working in a region with a lower population. The parameters of the characteristics can be set in a binary fashion (e.g., one parameter value for a location characteristic considered to be a large city and another parameter value for a location characteristic considered not to be a large city) or in a multi-level fashion (e.g., setting a different parameter value for more than two subsets of location such as by setting one parameter value for a large city location characteristic, one parameter value for a medium city location characteristic, and one parameter value for a small city location characteristic, or by setting one parameter value for each location, etc.).

In another example, some statistics show that a user with a job in the luxury goods or services, consumer services, family or individual entertainment, staffing and recruiting, publishing, computer networking, accounting, fashion and apparel, and real estate industry tends not to relocate for a job while a user with a job in the chemicals, food production, aviation, machinery, mechanical or electrical engineering, international affairs, military, research, mining and metals, and high education industry tend to relocate for a job.

In another example, some statistics show that a user that includes a job category characteristic of research, education, engineering, or military and protective services tend to relocate for job, while a user that includes a job category characteristic of accounting, administrative, real estate, human resources, support, sales, marketing, project management, product management, finance, arts and design, legal, community and social services, media and communication, entrepreneurship, tend not relocate for a job. Some statistics show that users with a job category characteristic of business development, operations, Information Technology (IT), purchasing, consulting, healthcare services, and quality assurance do not have a tendency with regard to relocating for a job.

In another example, some statistics show that a user with a job seniority characteristic of training, or chief officer (e.g., CEO, Chief Financial Officer (CFO), etc.) is likely to relocate for a job, while a user with a job seniority characteristic of unpaid, entry level, senior level, manager, director, and owner do not tend to relocate for a job. Some statistics show that a user that includes a job seniority characteristic of vice president or partner do not have a tendency with regard to relocating for a job (about fifty percent of vice presidents and partners relocate and about fifty percent do not relocate).

In another example, some statistics show that a user with a job category characteristic of accounts payable, administrative, accountant, accounts receivable, customer service, web designer, mortgage or loan, property manager, personal banker, or human resources are not likely to relocate for a job, while a user with a job category characteristic of student or intern, manufacturing, clinical research, business intern, college student, safety specialist, laboratory scientist, research student, graduate student, and Advance Business Application Programming (ABAP) or Systems Applications Products in Data Processing) developer, tend to relocate for a job.

In another example, some statistics show that a user with a characteristic that indicates the user is within about a year of completing education (e.g., a year before and a year after) has a higher tendency to relocate for a job than other educated persons. In another example, some statistics show that a user with a characteristic that indicates the user registered for a web service (e.g., LinkedIn®) between about four months and three years ago tend to have a higher probability of relocating for a job than other users of the social network service. In another example, some statistics show that a user with a characteristic that indicates they last updated their profile within the last two year is more likely to relocate for a job than other users.

In a final example, the latent preference module 104 can estimate that the user does not have a propensity to relocate in response to determining that substantially all of the jobs that a user has applied for are in a same general region as the user's current job (e.g., local to the user). In such a case, a user can be labeled as a local user and provided with only a job recommendation(s) that is local to the user.

As used herein, “local” can be determined on a case-by-case basis. For example, “local” in the context of a rural area can include a bigger region than “local” in the context of an urban region. In one or more embodiments, “local” can mean a fixed radius around the user's current home or job address (e.g., ten miles, twenty-five miles, fifty miles, etc.).

The results module 106 can determine whether the determined probability indicates that the item is a downside item or a potential upside item. The results module 106 can compare the determined probability to a threshold, such as to determine if the determined probability will be considered a downside item or a potential upside item. The threshold can be provided by a user or can be determined automatically (without human interference after programming). The threshold can be determined automatically using an estimated utility for a good recommendation that the user accepts (e.g., a true positive), an estimated utility for a bad recommendation that the user doesn't accept (e.g., a false positive), an estimated utility for missing a recommendation that the user would accept (e.g., a false negative), and an estimated utility of avoiding a bad recommendation (e.g., a true negative), such as is described in more detail below. The utility is described in more detail below in the discussion of multinomial regression. In the example of a user's propensity to relocate, the results module 106 can determine whether to present a user with a job recommendation associated with a job opportunity local to the user, not local to the user, or a combination thereof using the estimated probability.

The filter module 108 can filter out any items that are determined to be a downside item (e.g., by the results module 106), such as to only provide items determined to be potential upside items to a recommendation module 110. In the example of a user's propensity to relocate, the filter module 108 can filter out a job recommendation associated with a job that is not local to the user in response to the results module 106 determining to present the user with a job recommendation associated with a job opportunity local to the user. Alternatively, or in addition, the filter module 108 can filter out a job recommendation associated with a job that is local to the user in response to the results module 106 determining to present the user with a job recommendation associated with a job opportunity not local to the user.

The recommendation module 110 can determine which potential upside item(s) (if any) to recommend to a user. The recommendation module 110 can use a content-based recommendation method, a collaborative filtering recommendation method, a context-aware recommendation method, or a combination thereof, among other methods. The recommendation can be provided on the output line 112. The recommendation can be provided to the user interface module 304 of the social networking system 302, for example.

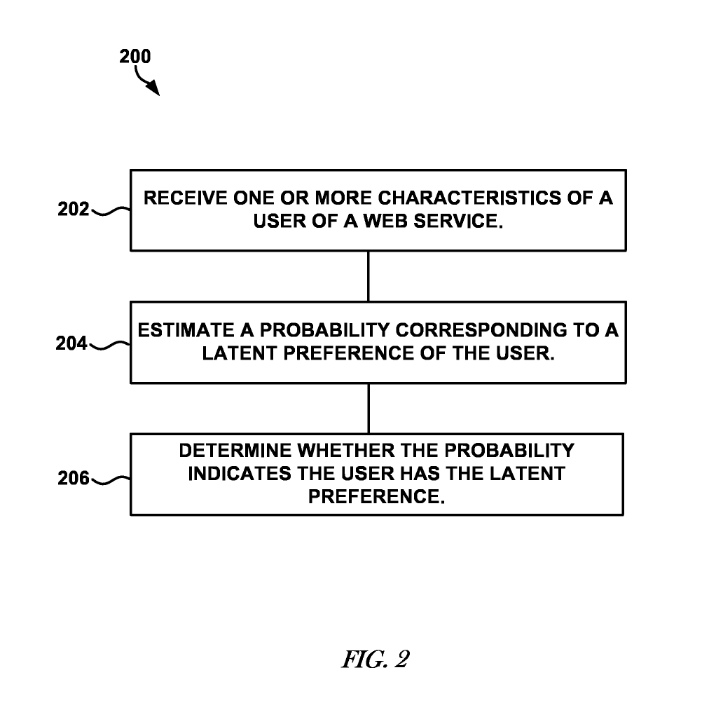

FIG. 2 shows a flow diagram of an example of a method 200 for determining a user's propensity to relocate for a job, in accord with one or more embodiments. The method can be implemented using one or more hardware processors and/or one or more of the modules discussed with regard to FIGS. 1, 3, and 4. The method 200 as illustrated includes: receiving one or more characteristics of a user of a web service, at operation 202; estimating a probability corresponding to a latent preference of the user, at operation 204; and determining whether the probability indicates the user has the latent preference, at operation 206. The latent preference can include a user's propensity to relocate for a job.

The operation at 204 can include using received characteristics and/or previously determined statistics (i.e. statistics determined a priori) regarding users including the same or similar characteristics to determine the probability. The operation at 204 can include estimating the probability using a multinomial regression model, a hierarchical Bayesian framework, or a hierarchical multinomial regression model of a plurality of users that include a characteristic that matches a characteristic of the user. The hierarchical multinomial regression can include a combination of a multinomial regression and a hierarchical Bayesian framework. The previously determined statistics can be used to determine a parameter associated with a characteristic that is used by the multinomial regression model, hierarchical Bayesian framework, or a combination thereof.

The characteristics of operation 202 can include at least one of an age of the user, industry classification of the user's current job, a gender of the user, a date the user registered for the web service, a date the user last modified the user's profile on the web service, an education status of the user, an amount of time the user has been working at the current job, a title associated with the user's current job, a geographical region of the user's current job, and a postal code associated with the user's current job.

The multinomial regression model or hierarchical regression model can be one of multiple hierarchical regression models, where each hierarchical regression model includes a segment of users that include a characteristic that matches a characteristic of other users in the same segment. A parameter (e.g., weighting factor) of a multinomial regression or hierarchical regression model associated with a characteristic of a particular segment can be different from the parameter of a hierarchical regression model associated with a different segment. The parameter can be determined using the previously determined statistic(s).

The operation at 206 can include determining whether to present a recommendation associated with an item that is consistent with the latent preference. The operation at 206 can include using the estimated probability to determine whether to present a user with a job opportunity local to the user. The operation at 206 can include comparing the estimated probability to a predetermined threshold. The predetermined threshold can be determined using a utility for a good recommendation that the user accepts, a utility for a bad recommendation that the user doesn't accept, a utility for missing a recommendation that the user would accept, and a utility of avoiding a bad recommendation.

The method 200 can include filtering out a recommendation associated with an item that is not consistent with the latent preference, such as in response determining the user has the latent preference. The method 200 can include filtering out a recommendation associated with an item that is consistent with the latent preference, such as in response determining the user does not have the latent preference. The method 200 can include determining a recommendation of a plurality of filtered recommendations to present to a user using at least one of contextual modeling, content-based filtering, or collaborative filtering, such as in response to filtering out the recommendation.

The method 200 can include filtering out a job recommendation associated with a job that is not local to the user in response determining to present the user with a job recommendation associated with a job opportunity local to the user. The method 200 can include filtering out a job recommendation associated with a job that is local to the user in response to determining to present the user with a job recommendation associated with a job opportunity not local to the user. The method 200 can include determining a job recommendation of a plurality of filtered job recommendations to present to a user using at least one of contextual modeling, content-based filtering, or collaborative filtering.

FIG. 3 is a diagram illustrating an example computer network environment 300, in accord with one or more embodiments. One or more modules of the latent preference determination system 100 can be implemented in or provide functionality to one or more modules of the environment 300. The computer network environment 300 can include a social networking system 302 that includes one or more application server modules 306 that provide any number of applications and services that leverage the social graph data database 328 maintained by the social networking system 302. For example, the social networking system 302 may provide a photo sharing application, a job posting and browsing service, a question-and-answer service, and so forth.

The social network environment 300 can provide a social networking service. A social networking service is an online service, platform and/or site that allows users of the service to build or reflect social networks or social relations among members. Typically, users construct profiles, which may include characteristics (e.g., personal information), such as the member's name, contact information, employment information, photographs, personal messages, status information, links to web-related content, blogs, and so on. In order to build or reflect these social networks or social relations among members, the social networking environment 300 allows members to identify, and establish links or connections with other members. For instance, in the context of a business networking service (a type of social networking service), a person may establish a link or connection with his or her business contacts, including work colleagues, clients, customers, personal contacts, and so on. With a social networking service, a person may establish links or connections with his or her friends, family, or business contacts. While a social networking service and a business networking service may be generally described in terms of typical use cases (e.g., for personal and business networking respectively), it will be understood by one of ordinary skill in the art with the benefit of Applicant's disclosure that a business networking service may be used for personal purposes (e.g., connecting with friends, classmates, former classmates, and the like) as well as, or instead of business networking purposes and a social networking service may likewise be used for business networking purposes as well as or in place of social networking purposes.

As shown in FIG. 3, the front end includes a user interface module (e.g., a web server) 304, which receives requests from various client-computing devices, and communicates appropriate responses to the requesting client devices. Client-computing devices, as shown in FIG. 3, can include a client 318 or client 320. The client 318 or 320 can include a device, such as a laptop, tablet, phone, Smartphone, desktop, Personal Digital Assistant (PDA), e-reader, or other computing device, such as a computing device capable of connecting to the internet. The client 318 or 320 can communicate with the social networking system using the user interface (UI) module 304. For example, the UI module 304 may receive requests in the form of Hypertext Transport Protocol (HTTP) request, File Transfer Protocol (FTP), Transmission Control Protocol (TCP)/Internet Protocol (IP), Simple Object Access Protocol (SOAP), or other web-based, Application Programming Interface (API) request.

The application logic layer can include various application server modules 306, which, in conjunction with the UI module 304, generate various UIs (e.g., web pages) with data retrieved from one or more sources of various data sources in the data layer. In some embodiments, individual application server modules 306 can be used to implement the functionality associated with various applications, services and/or features of the social networking environment 300. For instance, a social networking service may provide a broad variety of applications and services, to include the ability to search for and browse user profiles, job listings, or news articles. Additionally, applications and services may allow users to share content with one another, for example, via email, messages, and/or content postings (sometimes referred to as status updates) via a data feed (e.g., specifically tailored) to a user.

In connection with a job posting service, an automated (e.g., system or service-generated) content posting may be generated and communicated to a user to highlight a job that the user may be interested in. A wide variety and number of other applications or services may be made available to users of a social networking service, and will generally be embodied in their own instance of an application server module 306.

As shown in FIG. 3, the data layer includes several databases, such as a database 326 for storing profile data, including both user profile data as well as profile data for various entities (e.g., companies, schools, and other organizations) represented in the social graph maintained by the social networking service, such as in the social graph data database 328. Consistent with some embodiments, when a person initially registers to become a user of the social networking service, the person can be prompted to provide some personal information, such as his or her name, age (e.g., birthdate), gender, interests, contact information, home town, address, the names of the user's spouse and/or family users, educational background (e.g., schools, majors, matriculation and/or graduation dates, etc.), employment history, skills, professional organizations, and so on. This information, generally referred to as user profile information or user characteristic(s), is stored, for example, in the database 326.

Similarly, when a representative of an organization initially registers the organization with the social networking service (e.g., represented by the social networking system 302), the representative may be prompted to provide certain information about the organization. This information—generally referred to as company profile information—may be stored, for example, in the database 326 or another database (not shown). With some embodiments, the profile data may be processed (e.g., in the background or offline, by the offline data processing module 332) to generate various derived profile data. For example, if a user has provided information about various job titles the user has held with the same or different companies, or for how long, this information can be used to infer or derive a user profile attribute indicating the user's overall seniority level, or seniority level within a particular company. With some embodiments, importing or otherwise accessing data from one or more externally hosted data sources may enhance profile data for both users and organizations. For instance, with companies in particular, financial data may be imported from one or more external data sources, and made part of a company's profile.

Once registered, a user may invite other users, or be invited by other users, to connect via the environment 300. A “connection” may require a bi-lateral agreement by the users, such that both users acknowledge the establishment of the connection. Similarly, with some embodiments, a user may elect to “follow” another user. In contrast to establishing a connection, the concept of “following” another user typically can be a unilateral operation, and at least with some embodiments, does not require acknowledgement or approval by the user that is being followed. When one user follows another user, the user who is following may receive content postings, status updates, or other content postings published by the user being followed, or relating to various activities undertaken by the user being followed. Similarly, when a user follows an organization, the user becomes eligible to receive content postings published on behalf of the organization and/or system or service-generated content postings that relate to the organization. For instance, messages or content postings published on behalf of an organization that a user is following will appear in the user's personalized feed. In any case, the various associations and relationships that the users establish with other users, or with other entities and objects, can be stored and maintained within the social graph data database 328.

As users interact with the various applications, services, or content made available via the environment 300, the users' behavior (e.g., content viewed, links selected, etc.) may be monitored and information concerning the users' behavior may be stored, for example, in the user activity and behavior data database 330. This information may be used to infer a user's intent and/or interests, and to classify the user as being in various categories. For example, if the user performs frequent searches of job listings, thereby exhibiting behavior indicating that the user is a likely job seeker, this information can be used to classify the user as a job seeker. This classification can then be used as an attribute or characteristic. The attribute or characteristic can be used by others to target the user for receiving advertisements, messages, content postings, or a recommendation. Accordingly, a company that has available job openings can publish a content posting that is specifically directed to certain users (e.g., users) of the social networking service who are likely job seekers, and thus, more likely to be receptive to recruiting efforts.

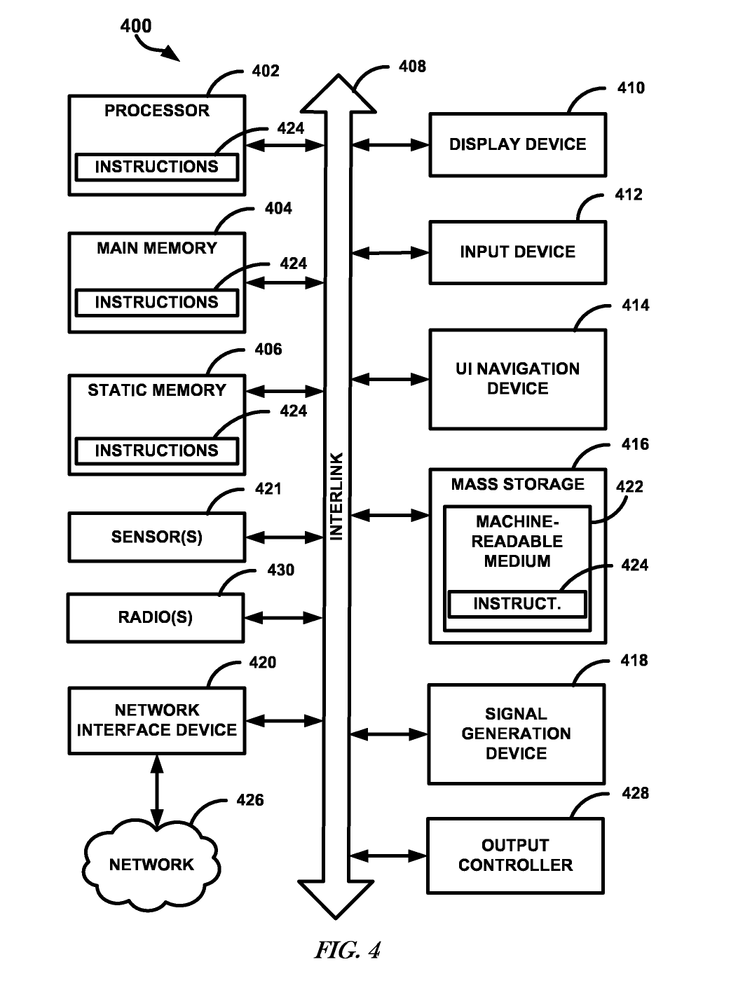

FIG. 4 shows a block diagram of an example of a computing device 400, in accord with one or more embodiments. The device 400 (e.g., a machine) can operate so as to perform one or more of the programming or communication techniques (e.g., methodologies) discussed herein. In some examples, the device 400 can operate as a standalone device or can be connected (e.g., networked) to one or more modules, such as the, as discussed herein. An item of the system 100 or environment 300 can include one or more of the items of the device 400. For example one or more of the characteristics module 102, latent preference module 104, results module 106, filter module 108, recommendation module 110, social networking system 302 (e.g., the user interface module 304 and/or the application server module(s)), and the offline data processing module 332 can include one or more of the items of the device 400.

Embodiments, as described herein, can include, or can operate on, logic or a number of components, modules, or mechanisms. Modules are tangible entities (e.g., hardware) capable of performing specified operations when operating. A module includes hardware. In an example, the hardware can be specifically configured to carry out a specific operation (e.g., hardwired). In an example, the hardware can include configurable execution units (e.g., transistors, logic gates (e.g., combinational and/or state logic), circuits, etc.) and a computer readable medium containing instructions, where the instructions configure the execution units to carry out a specific operation when in operation. The configuring can occur under the direction of the executions units or a loading mechanism. Accordingly, the execution units are communicatively can be coupled to the computer readable medium when the device is operating. In this example, the execution units can be a user of more than one module. For example, under operation, the execution units can be configured by a first set of instructions to implement a first module at one point in time and reconfigured by a second set of instructions to implement a second module.

Device (e.g., computer system) 400 can include a hardware processor 402 (e.g., a central processing unit (CPU), a graphics processing unit (GPU), a hardware processor core, or any combination thereof), a main memory 404 and a static memory 406, some or all of which can communicate with each other via an interlink (e.g., bus) 408. The device 400 can further include a display unit 410, an input device 412 (e.g., an alphanumeric keyboard), and a user interface (UI) navigation device 414 (e.g., a mouse). In an example, the display unit 410, input device 412 and UI navigation device 414 can be a touch screen display. The device 400 can additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The device 400 can include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). The device 400 can include one or more radios 430 (e.g., transmission, reception, or transceiver devices). The radios 430 can include one or more antennas to receive signal transmissions. The radios 430 can be coupled to or include the processor 402. The processor 402 can cause the radios 430 to perform one or more transmit or receive operations. Coupling the radios 430 to such a processor can be considered configuring the radio 430 to perform such operations.

The storage device 416 can include a machine readable medium 422 on which is stored one or more sets of data structures or instructions 424 (e.g., software) embodying or utilized by any one or more of the techniques or functions described herein. The instructions 424 can also reside, completely or at least partially, within the main memory 404, within static memory 406, or within the hardware processor 402 during execution thereof by the device 400. In an example, one or any combination of the hardware processor 402, the main memory 404, the static memory 406, or the storage device 416 can constitute machine readable media.

While the machine readable medium 422 is illustrated as a single medium, the term “machine readable medium” can include a single medium or multiple media (e.g., a centralized or distributed database, and/or associated caches and servers) configured to store the one or more instructions 424. The term “machine readable medium” can include any tangible medium that is capable of storing, encoding, or carrying instructions for execution by the device 400 and that cause the device 400 to perform any one or more of the techniques of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 424 can further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 420 can include one or more physical jacks (e.g., Ethernet, coaxial, or phone jacks) or one or more antennas to connect to the communications network 426. In an example, the network interface device 420 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the device 400, and includes digital or analog communications signals or other intangible medium to facilitate communication of such software.

What follows is a discussion of multinomial regression and hierarchical Bayesian framework.

The following notations are used here: u=1, 2, . . . , U, where u is the index of the user; j=1, 2, . . . , J, where j is the index of the item (e.g., a content item); m=1, 2, . . . , M, where m is the index of the segment for a user; D={D₁, . . . , Dₘ, . . . , D_{M}}, where D is the observed data of all segments from all users; Dₘ={y_{m,i}, x_{m,i}}, where Dₘ is a set of observed data associated with segment m. Each segment m has Nₘ data observations from all users in that segment. Each observation i=1, . . . , Nₘ in segment m is associated with two parts, the preference label y_{m,i} and the characteristic vector x_{m,i}. wherein, y_{m,i} is the preference label with the ith observation in segment m. It can be a binary choice (staying at the current location or not) or a multi-class choice (work in Information Technology (IT) industry, financing industry, education industry, etc.). The index of the candidate choice is k=1, 2, . . . , K. Where x_{m,i} is the d-dimensional vector of a characteristics associated with the ith observation in segment m. Characteristics can include a static demographic or a dynamic behavior characteristic. The goal of the model is to predict the probability that user u has the latent preference y_{m,i}=k, given that the user belongs to segment m and has character vector x_{m,i}.

A basic discussion of multinomial regression is presented for convenience. Multinomial regression can be used to solve multi-class classification problems (e.g., predicting the probability of a user having the latent preference y_{m,i}=k given the user characteristic vector x_{m,i}). The probability can be estimated based on one or more characteristics as follows: p(y_{m,i}=k|θ)=exp{θ^{T}ₖx_{m,i}}/sum(exp{θ^{T}_{k′}x_{m,i}}), where θ=θ₁, . . . , θ_{K} is a model parameter (e.g., a number between zero and one) to be learned from training data. In basic multinomial regression, all users share the same parameter θ. Assuming the prior distribution of each model parameter is a Gaussian centered on zero, the parameter θ can be learned from training data using a maximum a posteriori probability (MAP) estimation, for example.

For each segment, m, θₘ can be sampled from a Gaussian distribution: θₘ˜N(μ_{θ}, Σ_{θ}). The notation φ=(μ_{θ}, Σ_{θ}) is used for convenience herein. For each ith observation in segment, m, with its observed features, x_{m,i}, its latent preference model, y_{m,i}, is sampled from the multinomial regression model, p(y_{m,i}=k|θ)=exp{θ^{T}ₖ x_{m,i}}/sum(exp{θ^{T}_{k′} x_{m,i}}).

Consider that data, D, consists of a series of observations from all segments. The latent preferences in the observations are determined by using a set of hidden variables, θ=θ₁, . . . , θ_{M}. Note that the core model does not need to be multinomial regression. Other suitable models such as a proportional hazards model can be used. Note that θₘ can contain all parameters in the core model.

The data likelihood can be written as a function of φ=(μ_{θ}, Σ_{θ}). y_{m,i} can be represented by {y_{m,i}, . . . , y_{m,i}, . . . , y_{m,Nm}} (i.e., preference observations in segment m), such that p(D|φ)=Πₘ₌₁^{M}p(yₘ|φ)=Πₘ₌₁^{M}∫p(θₘ, yₘ|φ)dθₘ.

There is no known closed-form solution for the estimation of model parameters. Herein, a hierarchical (e.g., variational) Bayesian method for a constrained (approximate) solution is used to help derive an iterative process to find an approximate solution. Note that maximizing the data likelihood is equivalent to maximizing the log data likelihood L(φ), such that L(φ)=ln(p(D|φ)=Πₘ₌₁^{M} ln(p(yₘ|φ)=Πₘ₌₁^{M} ln∫p(θₘ, yₘ|φdθₘ.

The problem can be simplified by introducing an auxiliary distribution q(θₘ) for each hidden variable θₘ. Using the variational approach, q(θₘ) can be constrained to be a particular tractable form for computational efficiency. In particular, it can be assumed that q(θₘ)=N(μ_{θm}, Σ_{θm}). The process to infer parameters is to iterate between an E-step and M-step until convergence.

In the E-step, a posterior distribution over a hidden variable θₘ is inferred given φ, such as to determine q(θₘ) that maximizes L(φ). Note that L(φ)=Πₘ₌₁^{M} ln

$$L ( ϕ ) = {\sum }_{m = 1}^{M} ln \int \frac{q ( {θ}_{m} ) p ( {θ}_{m} , {y}_{m} \vert ϕ )}{q ( {θ}_{m} )} d {θ}_{m} \geq {\sum }_{m = 1}^{M} \int ln [ \frac{q ( {θ}_{m} ) p ( {θ}_{m} , {y}_{m} \vert ϕ )}{q ( {θ}_{m} )} ] d {θ}_{m} = {\sum }_{m = 1}^{M} \int q ( {θ}_{m} ) ln ( p ( {y}_{m} \vert ϕ ) d {θ}_{m} - {\sum }_{m = 1}^{M} q ( {θ}_{m} ) ln [ \frac{q ( {θ}_{m} )}{p ( {θ}_{m} \vert {y}_{m} , ϕ )} ] d {θ}_{m} ≡ F ( q ( {θ}_{1} ) , … , q ( {θ}_{M} ) , ϕ ) .$$

Maximizing L(φ) can be equivalent to minimizing the following quantity to find each distribution q(θₘ), which can include the KL-divergence between the variational distribution q(θₘ) and the exact hidden variable posterior

$$p ( {θ}_{m} \vert {y}_{m} , ϕ ) \cdot q ( {θ}_{m} ) = {argmin}_{q ( {θ}_{m} )} \int q ( {θ}_{m} ) ln [ \frac{q ( {θ}_{m} )}{p ( {θ}_{m} \vert {y}_{m} , ϕ )} ] d {θ}_{m} .$$

Given that p(θₘ|yₘ, φ)=p(yₘ|θₘ)p(θₘ|φ)/p(yₘ|φ); q(θₘ)=arg min_{q(θ}_{ₘ}₎ KL[q(θₘ)∥p(θₘ|φ)]−∫q(θₘ)ln [p(yₘ|θₘ)] dθₘ, where KL is the KL-divergence between the posterior distribution q(θₘ) and the exact prior distribution p(θₘ|φ). The KL divergence between two Gaussian distributions can be written as

$$KL [ q ( {θ}_{m} ) \vert \vert p ( {θ}_{m} \vert ϕ ) ] = \frac{1}{2} [ tr ( {\sum }_{θ}^{- 1} {\sum }_{{θ}_{m}} ) + {( {μ}_{θ} - {μ}_{{θ}_{m}} )}^{T} {\sum }_{θ}^{- 1} ( {μ}_{θ} - {μ}_{{θ}_{m}} ) - ln [ det ( {θ}_{m} ) / det ( θ ) ] - d ] .$$

The other part of the equation that includes the KL divergence, ∫q(θₘ)ln [p(yₘ|θₘ)] dθₘ, is to help maximize the likelihood of y_{m,i}={y_{m,1}, . . . , y_{m,i}, . . . , y_{m,Nm}} with the current θₘ, such that Σᵢ₌₁^{N}^{ₘ}∫q(θₘ)ln [p(y_{m,i}=k|θₘ)dθₘ=Σᵢ₌₁^{N}^{ₘ}∫∫q(θₘ)ln [p(y_{m,i}=k|θₘ)dθₘ=Σᵢ₌₁^{N}^{ₘ}[E(θ_{m,k})^{T}x_{m,i}−E(ln Σ_{k′}exp(θ_{m,k′}^{T}x_{m,i}))].

The expectation E(θ_{m,k}) is μ_{θ}_{_{m,k}}. There is no known closed form solution for the expectation δ=E(ln Σ_{k′}exp(θ_{m,k′}^{T}x_{m,i})). The moment generating function for such a multivariate normal distribution is E[exp(θ_{m,k′}^{T}x_{m,i})]=exp(μ_{θ}_{_{m,k′}}^{T}x_{m,i})+½ x_{m,i}^{T}Σ_{θ}_{_{m,k′}}x_{m,i}). An upper bound of δ can be determined. Such an upper bound can be E(ln Σ_{k′}exp(θ_{m,k′}^{T}x_{m,i}))<γΣ_{k′}exp(μ_{θ}_{_{m,k′}}^{T}x_{m,i}+½ x_{m,i}^{T}Σ_{θ}_{_{m,k′}}^{T}x_{m,i})−log(γ)−1, for every γεk-dimensional real number space. These derivations can be combined with a conjugate gradient descent method to help determine q(θₘ).

In the M-step, a goal can be to maximize F(q(θ₁), . . . , q(θₘ), φ), with respect to φ, given all θₘ. Maximizing F(q(θ₁), . . . , q(θₘ), φ) can be equivalent to maximizing φ^{(t+1)}←arg max_{φ}Σₘ₌₁^{M}∫q(θₘ)ln [p(y_{m,i}|φ)dθₘ. A closed form solution for μ_{θ} and Σ_{θ}. (μ_{θ}, Σ_{θ})←arg max_{μ}_{_{θ}}_{,Σ}_{_{θ}}Σₘ₌₁^{M}∫q(θₘ)ln [p(yₘ|θₘ)p(θₘ|μ_{θ}, Σ_{θ})]dθₘ ∝ arg max_{μ}_{_{θ}}_{,Σ}_{_{θ}}Σₘ₌₁^{M}∫q(θₘ)ln [P(θₘ|μ_{θ}, Σ_{θ})]dθₘ=arg max_{μ}_{_{θ}}_{,Σ}_{_{θ}}Σₘ₌₁^{M} ln

$$1 / \sqrt{{( 2 π )}^{k} \vert {\sum }_{θ} \vert} - \frac{1}{2} E [ {( {θ}_{m} - {μ}_{θ} )}^{T} {\sum }_{θ}^{- 1} ( {θ}_{m} - {μ}_{θ} ) ] .$$

By setting the first derivative to zero, closed form solutions for μ_{θ} and Σ_{θ} can be determined as:

$${μ}_{θ} = \frac{{\sum }_{m}^{M} {μ}_{θ m}}{M}$$

$${Σ}_{θ} = \frac{{\sum }_{m}^{M} [ {Σ}_{θ m} + ( {μ}_{θ m} - {μ}_{θ} ) {( {μ}_{θ m} - {μ}_{θ} )}^{T} ]}{M} .$$

Let p(u, j) be the joint probability of user, u, accepting item j. The match from an existing recommender system and the prediction of the user's latent preference can be used in determining the probability. p(u, j) could be estimated by the following equation: P(u, j)=p_{rec}(u, j)Σₖ[p(y_{m,i}=k)I_{jεS(u,k)}], where p_{rec} is the matching probability between user u and item j, which could be predicted by an upside recommender system. p(y_{m,i}=k) is the probability of user, u, associated with observation, i, having a specific latent preference k. It is predicted by the user latent preference model, as discussed previously. S(u, k) contains all items that match with the user's preference. For example, if user, u, is predicted to seek jobs in his local area, S(u, k)=“local” contains all local jobs. Note that the candidates of a user's preference k=1, 2, . . . , K can all be exclusive and item, j, can only belong to one set S(u, k). I_{*} is an indicator function which equals to 1 if * is true. So,

$$p ( {y}_{m , i} = k = E [ \frac{exp \{ {θ}_{k}^{T} {x}_{m , i} \}}{sum ( exp \{ {θ}_{k}^{T} , {x}_{m , i} \} )} ] ,$$

where E[exp{θₖ^{T}x_{m,i}}]=μ_{θ}_{ₖ}^{T}x_{m,i}+0.5x_{m,i}^{T}Σ_{θ}_{ₖ}x_{m,i}.

As previously discussed, the recommender systems aim to send recommendations to a user that can increase user satisfaction. While a good recommendation (upside item) can increase the user satisfaction, a bad recommendation (downside item) can decrease the user satisfaction.

Next, the utility for a variety of types of recommendations is discussed. Let u_{TP} be the utility for a good recommendation that the user accepts (e.g., a true positive), u_{FP} be the utility for a bad recommendation that the user doesn't accept (e.g., a false positive), u_{FN} be the utility for missing a recommendation that the user would accept (e.g., a false negative), and u_{TN} be the utility of avoiding a bad recommendation (e.g., a true negative). The utility (i.e. value) for each type of recommendation (u_{TP}, u_{FP}, u_{FN}, and u_{TN}) could be set by, for example, a user or a domain expert. The user, u's, satisfaction of a recommendation set utility can be estimated as follows:

utility=sum(u_{TP}I_{show,accept},u_{FP}I_{show,accept},u_{FN}I_{show,accept},u_{TN}I_{show,accept}).

To achieve a better user satisfaction or utility, the system with a filtering component can send a recommendation only if the expected utility of an item is higher than zero. The system can send a recommendation if the joint probability of a user accepting the item, p(u, j), is higher than a threshold a. The filtering threshold a can be determined (e.g., automatically) using the utility set as

$$α = \frac{{u}_{FP} - {u}_{TN}}{{u}_{FP} - {u}_{TN} + {u}_{FN} - {u}_{TP}} .$$

### EXAMPLES AND NOTES

The present subject matter can be described by way of several examples.

Example 1 can include or use subject matter (such as an apparatus, a method, a means for performing acts, or a device readable memory including instructions that, when performed by the device, can cause the device to perform acts), such as can include or use one or more of a characteristics module, executable by one or more processors, to receive one or more characteristics of a user of a web service, a latent preference module, executable by the one or more processors, to estimate a probability corresponding to a propensity of the user to relocate for a job using the one or more received characteristics of the user, and a results module, executable by the one or more processors, to determine whether to present a user with a job recommendation associated with a job opportunity local to the user using the estimated probability.

Example 2 can include or use, or can optionally be combined with the subject matter of Example 1, to include or use, wherein the latent preference module to estimate the probability includes the latent preference module to estimate the probability using a multinomial regression model of a plurality of users that include a characteristic that matches a characteristic of the user.

Example 3 can include or use, or can optionally be combined with the subject matter of Example 2, to include or use, wherein the multinomial regression model is one of a plurality of multinomial regression models each corresponding to a segment of users, wherein each segment includes only users with a specific characteristic, and wherein a parameter of a multinomial regression model associated with the characteristic of a particular segment are different from the parameter of a multinomial regression model associated with another segment.

Example 4 can include or use, or can optionally be combined with the subject matter of at least one of Examples 2-3, to include or use, wherein the latent preferences module to estimate the probability includes the latent preference module to estimate the probability further using a hierarchical Bayesian framework.

Example 5 can include or use, or can optionally be combined with the subject matter of at least one of Examples 1-4, to include or use, wherein the characteristics of the user include at least one of an age of the user, industry classification of the user's current job, a gender of the user, a date the user registered for the web service, a date the user last modified the user's profile on the web service, an education status of the user, an amount of time the user has been working at the current job, a title associated with the user's current job, a geographical region of the user's current job, and a postal code associated with the user's current job.

Example 6 can include or use, or can optionally be combined with the subject matter of at least one of Examples 1-5, to include or use, wherein the results module to determine whether to present a user with a local job recommendation includes the results module to compare an estimated probability from the latent preferences module to a predetermined threshold.

Example 7 can include or use, or can optionally be combined with the subject matter of Example 6, to include or use, wherein the predetermined threshold is determined automatically using an estimated utility for a good recommendation that the user accepts, a utility for a bad recommendation that the user does not accept, a utility for missing a recommendation that the user would accept, and a utility of avoiding a bad recommendation.

Example 8 can include or use, or can optionally be combined with the subject matter of at least one of Examples 1-7, to include or use, wherein the latent preference module to estimate the probability corresponding to a propensity of the user to relocate includes estimating that the user does not have a propensity to relocate in response to determining that substantially all of the jobs that a user applied to were in a same general region as the user's current job.

Example 9 can include or use, or can optionally be combined with the subject matter of at least one of Examples 1-8, to include or use a filter module, executable by one or more processors, to filter out a job recommendation associated with a job that is not local to the user in response to the results module determining to present the user with a job recommendation associated with a job opportunity local to the user and to filter out a job recommendation associated with a job that is local to the user in response to the results module determining to present the user with a job recommendation associated with a job opportunity not local to the user.

Example 10 can include or use, or can optionally be combined with the subject matter of Example 9, to include or use, a recommendation module, executable by one or more processors, to receive a plurality of potential job recommendations after the filter module has filtered out one or more job recommendations of the plurality of potential job recommendations and determine a job recommendation of the plurality of job recommendations to present to a user using at least one of contextual modeling, content-based filtering, or collaborative filtering.

Example 11 can include or use subject matter (such as an apparatus, a method, a means for performing acts, or a device readable memory including instructions that, when performed by the device, can cause the device to perform acts), such as can include or use receiving one or more characteristics of a user of a web service, estimating a probability corresponding to a propensity of the user to relocate for a job using the one or more received characteristics of the user, and determining whether to present a user with a job recommendation associated with a job opportunity local to the user using the estimated probability.

Example 12 can include or use, or can optionally be combined with the subject matter of Example 11, to include or use, wherein estimating the probability includes estimating the probability using a hierarchical multinomial regression model of a plurality of users that include a characteristic that matches a characteristic of the user, wherein the hierarchical multinomial regression includes a multinomial regression and a hierarchical Bayesian framework.

Example 13 can include or use, or can optionally be combined with the subject matter of Example 12, to include or use, wherein the multinomial regression model is one of a plurality of multinomial regression models each corresponding to a segment of users, each segment includes only users with a specific characteristic, and a parameter of a multinomial regression model associated with the characteristic of a particular segment are different from the parameter of a multinomial regression model associated with another segment.

Example 14 can include or use, or can optionally be combined with the subject matter of at least one of Examples 11-13, to include or use, wherein, the characteristics of the user includes at least one of an age of the user, industry classification of the user's current job, a gender of the user, a date the user registered for the web service, a date the user last modified the user's profile on the web service, an education status of the user, an amount of time the user has been working at the current job, a title associated with the user's current job, a geographical region of the user's current job, and a postal code associated with the user's current job.

Example 15 can include or use, or can optionally be combined with the subject matter of at least one of Examples 11-14, to include or use, wherein determining whether to present a user with a local job recommendation includes comparing the estimated probability to a predetermined threshold.

Example 16 can include or use, or can optionally be combined with the subject matter of Example 15, to include or use, wherein the predetermined threshold is determined using a utility for a good recommendation that the user accepts, a utility for a bad recommendation that the user does not accept, a utility for missing a recommendation that the user would accept, and a utility of avoiding a bad recommendation.

Example 17 can include or use, or can optionally be combined with the subject matter of at least one of Examples 11-16, to include or use filtering out a job recommendation associated with a job that is not local to the user in response determining to present the user with a job recommendation associated with a job opportunity local to the user.

Example 18 can include or use, or can optionally be combined with the subject matter of at least one of Examples 11-17, to include or use filtering out a job recommendation associated with a job that is local to the user in response to determining to present the user with a job recommendation associated with a job opportunity not local to the user.

Example 19 can include or use, or can optionally be combined with the subject matter of at least one of Examples 17-18, to include or use determining a job recommendation of a plurality of filtered job recommendations to present to a user using at least one of contextual modeling, content-based filtering, or collaborative filtering.

Example 20 can include or use subject matter (such as an apparatus, a method, a means for performing acts, or a device readable memory including instructions that, when performed by the device, can cause the device to perform acts), such as can include or use receiving one or more characteristics of a user of a web service, estimating a probability corresponding to a latent preference of the user, and determining whether the probability indicates the user has the latent preference.

Example 20 can include or use, or can optionally be combined with the subject matter of Example 19, to include or use, wherein estimating the probability includes using a hierarchical multinomial regression model of a plurality of users that include a characteristic that matches a characteristic of the user, wherein the hierarchical multinomial regression model includes a multinomial regression and a hierarchical Bayesian framework.

Example 21 can include or use, or can optionally be combined with the subject matter of Example 20, to include or use, wherein: (1) the hierarchical regression model is one of multiple hierarchical regression models and wherein the user is one of a plurality of users that have registered for a web service, wherein each hierarchical regression model of the multiple hierarchical regression models includes a segment of users of the plurality of users, wherein each user of the users of the segment includes a characteristic that matches a characteristic of other users in the same segment, and wherein parameters of a hierarchical regression model associated with a particular segment are different from the parameters of a hierarchical regression model associated with another segment, or (2) the characteristics of the user includes at least one of an age of the user, industry classification of the user's current job, a gender of the user, a date the user registered for the web service, a date the user last modified the user's profile on the web service, an education status of the user, an amount of time the user has been working at the current job, a title associated with the user's current job, a geographical region of the user's current job, and a postal code associated with the user's current job.

Example 22 can include or use, or can optionally be combined with the subject matter of at least one of Examples 20-21, to include or use, wherein determining whether the probability indicates the user has the latent preference includes comparing the estimated probability to a predetermined threshold, wherein the predetermined threshold is determined using a utility for a good recommendation that the user accepts, a utility for a bad recommendation that the user doesn't accept, a utility for missing a recommendation that the user would accept, and a utility of avoiding a bad recommendation.

Example 23 can include or use, or can optionally be combined with the subject matter of at least one of Examples 20-22, to include or use filtering out a recommendation associated with an item that is not consistent with the latent preference in response determining the user has the latent preference, filtering out a recommendation associated with an item that is consistent with the latent preference in response determining the user does not have the latent preference, or in response to filtering out the recommendation, determining a recommendation of a plurality of filtered recommendations to present to a user using at least one of contextual modeling, content-based filtering, or collaborative filtering.

The above Description of Embodiments includes references to the accompanying drawings, which form a part of the detailed description. The drawings show, by way of illustration, specific embodiments in which methods, apparatuses, and systems discussed herein can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

The flowchart and block diagrams in the FIGS. illustrate the architecture, functionality, and operation of possible implementations of systems, methods and computer program products according to various aspects of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The functions or techniques described herein can be implemented in software or a combination of software and human implemented procedures. The software can consist of computer executable instructions stored on computer readable media such as memory or other type of storage devices. The term “computer readable media” is also used to represent any means by which the computer readable instructions can be received by the computer, such as by different forms of wired or wireless transmissions. Further, such functions correspond to modules, which are software, hardware, firmware or any combination thereof. Multiple functions can be performed in one or more modules as desired, and the embodiments described are merely examples. The software can be executed on a digital signal processor, ASIC, microprocessor, or other type of processor operating on a computer system, such as a personal computer, server or other computer system.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Description of Embodiments, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Description of Embodiments as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A non-transitory computer readable medium comprising instructions stored thereon, which when executed by a machine cause the machine to:
receive one or more characteristics of a user of a web service;
estimate a probability corresponding to a propensity of the user to relocate for a job using the one or more received characteristics of the user; and
determine whether to present a user with a job recommendation associated with a job opportunity local to the user using the estimated probability.

2. The computer readable medium of claim 1, wherein the instructions for estimating the probability include instructions, which when executed by the machine, cause the machine to estimate the probability using a multinomial regression model of a plurality of users that include a characteristic that matches a characteristic of the user.

3. The computer readable medium of claim 2, wherein the multinomial regression model is one of a plurality of multinomial regression models each corresponding to a segment of users, wherein each segment includes only users with a specific characteristic, and wherein a parameter of a multinomial regression model associated with the characteristic of a particular segment is different from the parameter of a multinomial regression model associated with another segment.

4. The computer readable medium of claim 3, wherein the instructions for estimating the probability include instructions, which when executed by the machine, cause the machine to estimate the probability further using a hierarchical Bayesian framework.

5. The computer readable medium of claim 1, wherein the characteristics of the user include at least one of an age of the user, industry classification of the user's current job, a gender of the user, a date the user registered for the web service, a date the user last modified the user's profile on the web service, an education status of the user, an amount of time the user has been working at the current job, a title associated with the user's current job, a geographical region of the user's current job, and a postal code associated with the user's current job.

6. The computer readable medium of claim 1, wherein the instructions for determining whether to present a user with a local job recommendation include instructions, which when executed by the machine, cause the machine to compare an estimated probability from the latent preferences module to a predetermined threshold.

7. The computer readable medium of claim 6, wherein the predetermined threshold is determined automatically using an estimated utility for a good recommendation that the user accepts, a utility for a bad recommendation that the user does not accept, a utility for missing a recommendation that the user would accept, and a utility of avoiding a bad recommendation.

8. The computer readable medium of claim 1, wherein the instructions for estimating the probability corresponding to a propensity of the user to relocate include instructions, which when executed by the machine, cause the machine to estimate that the user does not have a propensity to relocate in response to determining that substantially all of the jobs that a user applied to were in a same general region as the user's current job.

9. The computer readable medium of claim 1, further comprising instructions, which when executed by the machine, cause the machine to filter out a job recommendation associated with a job that is not local to the user in response to the results module determining to present the user with a job recommendation associated with a job opportunity local to the user and to filter out a job recommendation associated with a job that is local to the user in response to the results module determining to present the user with a job recommendation associated with a job opportunity not local to the user.

10. The computer readable medium of claim 9, further comprising instructions, which when executed by the machine, cause the machine to receive a plurality of potential job recommendations after the filter module has filtered out one or more job recommendations of the plurality of potential job recommendations and determine a job recommendation of the plurality of job recommendations to present to a user using at least one of contextual modeling, content-based filtering, or collaborative filtering.

11. A method comprising operations performed using one or more hardware processors, the operations comprising:
receiving one or more characteristics of a user of a web service;
estimating a probability corresponding to a propensity of the user to relocate for a job using the one or more received characteristics of the user; and
determining whether to present a user with a job recommendation associated with a job opportunity local to the user using the estimated probability.

12. The method of claim 11, wherein estimating the probability includes estimating the probability using a hierarchical multinomial regression model of a plurality of users that include a characteristic that matches a characteristic of the user, wherein the hierarchical multinomial regression includes a multinomial regression and a hierarchical Bayesian framework.

13. The method of claim 12, wherein:
the multinomial regression model is one of a plurality of multinomial regression models each corresponding to a segment of users, each segment includes only users with a specific characteristic, and a parameter of a multinomial regression model associated with the characteristic of a particular segment are different from the parameter of a multinomial regression model associated with another segment; and
the characteristics of the user includes at least one of an age of the user, industry classification of the user's current job, a gender of the user, a date the user registered for the web service, a date the user last modified the user's profile on the web service, an education status of the user, an amount of time the user has been working at the current job, a title associated with the user's current job, a geographical region of the user's current job, and a postal code associated with the user's current job.

14. The method of claim 11, wherein determining whether to present a user with a local job recommendation includes comparing the estimated probability to a predetermined threshold, wherein the predetermined threshold is determined using a utility for a good recommendation that the user accepts, a utility for a bad recommendation that the user does not accept, a utility for missing a recommendation that the user would accept, and a utility of avoiding a bad recommendation.

15. The method of claim 11, further comprising:
filtering out a job recommendation associated with a job that is not local to the user in response determining to present the user with a job recommendation associated with a job opportunity local to the user;
filtering out a job recommendation associated with a job that is local to the user in response to determining to present the user with a job recommendation associated with a job opportunity not local to the user; and
determining a job recommendation of a plurality of filtered job recommendations to present to a user using at least one of contextual modeling, content-based filtering, or collaborative filtering.

16. A method comprising:
receiving one or more characteristics of a user of a web service;
estimating a probability corresponding to a latent preference of the user; and
determining whether the probability indicates the user has the latent preference.

17. The method of claim 16, wherein estimating the probability includes using a hierarchical multinomial regression model of a plurality of users that include a characteristic that matches a characteristic of the user, wherein the hierarchical multinomial regression model includes a multinomial regression and a hierarchical Bayesian framework.

18. The method of claim 17, wherein:
the hierarchical regression model is one of multiple hierarchical regression models and wherein the user is one of a plurality of users that have registered for a web service, wherein each hierarchical regression model of the multiple hierarchical regression models includes a segment of users of the plurality of users, wherein each user of the users of the segment includes a characteristic that matches a characteristic of other users in the same segment, and wherein parameters of a hierarchical regression model associated with a particular segment are different from the parameters of a hierarchical regression model associated with another segment; and
the characteristics of the user includes at least one of an age of the user, industry classification of the user's current job, a gender of the user, a date the user registered for the web service, a date the user last modified the user's profile on the web service, an education status of the user, an amount of time the user has been working at the current job, a title associated with the user's current job, a geographical region of the user's current job, and a postal code associated with the user's current job.

19. The method of claim 16, wherein determining whether the probability indicates the user has the latent preference includes comparing the estimated probability to a predetermined threshold, wherein the predetermined threshold is determined using a utility for a good recommendation that the user accepts, a utility for a bad recommendation that the user doesn't accept, a utility for missing a recommendation that the user would accept, and a utility of avoiding a bad recommendation.

20. The method of claim 16, further comprising:
filtering out a recommendation associated with an item that is not consistent with the latent preference in response determining the user has the latent preference;
filtering out a recommendation associated with an item that is consistent with the latent preference in response determining the user does not have the latent preference; and
in response to filtering out the recommendation, determining a recommendation of a plurality of filtered recommendations to present to a user using at least one of contextual modeling, content-based filtering, or collaborative filtering.
